(19) United States
(12) Patent Application Publication
(10) Pub. No.: US 2013/0151438 A1
(43) Pub. Date: Jun. 13, 2013

(54) Relative Value Volatility Index Apparatuses, Methods, and Systems

(71) Applicants: Bogdan N. Ianev, New York, NY (US); Ciprian Ticula, New York, NY (US)

(72) Inventors: Bogdan N. Ianev, New York, NY (US); Ciprian Ticula, New York, NY (US)

(21) Appl. No.: 13/712,963

(22) Filed: Dec. 12, 2012

Related U.S. Application Data
(60) Provisional application No. 61/569,742, filed on Dec. 12, 2011.

(51) Int. Cl. G06Q 40/06

(52) U.S. Cl. CPC G06Q 40/06
USPC 705/36 R

(57) ABSTRACT

A rule-based signal-driven algorithmic index and associated financial products for generating returns by trading the relative performance of the short-term of an implied volatility curve for a stock index versus a medium-term of the same implied volatility curve, as tracked by a short-term index and a medium-term index, respectively, based on the steepness of the short-term end of the curve versus the steepness of the medium-term end of the curve.

### PRIORITY CLAIM

This application claims priority under 35 U.S.C. §119 to U.S. Provisional Patent Application No. 61/569,742, filed Dec. 12, 2011, the contents of which are incorporated by reference herein in their entirety.

### FIELD

The present invention is directed generally to methods and systems for creating financial indices and financial instruments. More particularly, the invention is directed to RELATIVE VALUE VOLATILITY INDEX APPARATUSES, METHODS, AND SYSTEMS (hereinafter RVOL).

### BACKGROUND

Volatility may be used as a measure of financial risk associated with a given financial instrument. For example, the standard deviation of the performance of a given instrument, collection of instruments, or index is one way to measure or define volatility. Like the value of the underlying assets, the volatility may also vary with time and market conditions. There are two types of volatility, one backward looking, and one forward looking. The backward-looking measure of volatility is called realized volatility and is determined by the historical price fluctuations of a given investment. The forward-looking measure of volatility is called implied volatility which may be determined by evaluating a current price of a given investment together with an appropriate pricing model predicting the price of the investment at some time in the future. Instruments that exhibit high volatility may be considered more risky than those with lower volatility.

### BRIEF DESCRIPTION OF THE DRAWINGS

The accompanying drawings and appendices illustrate various non-limiting, example, inventive aspects in accordance with the present disclosure:

FIG. 1 shows a schematic illustration of data flows between RVOL components and affiliated entities in one embodiment of RVOL operation;

FIG. 2 shows aspects of RVOL architecture in block-diagram form and data flow between and among RVOL components in one embodiment of RVOL operation;

FIGS. 3A and 3B show an exemplary logic flow in one embodiment of RVOL operation; and

FIG. 4 is a block diagram illustrating embodiments of the RVOL controller.

### DETAILED DESCRIPTION

### RVOL

This disclosure describes relative value volatility index apparatuses, methods, and systems (RVOL) as well as associated financial products. Depending on the particular needs and characteristics of a RVOL user and their systems, various embodiments of the RVOL may be implemented that enable a great deal of flexibility and customization.

A processor-implemented method for maintaining a relative value volatility index is disclosed. The method includes using an index calculator module to calculate a daily signal based on the slope of a short-term portion of a volatility index futures curve and the slope of a medium-term portion of the volatility index futures curve, and using the index calculator module to calculate a daily value for the relative value volatility index based on the signal. Calculating the daily signal may include calculating the slope of the short-term portion of the volatility index futures curve, calculating the slope of the medium-term portion of the volatility index futures curve, and calculating the difference between these two slopes. Calculating the slope of the short-term portion of the volatility index futures curve may include subtracting the value of a one-month futures contract for the volatility index on a given day from the value of a two-month futures contract for the volatility index on the same day; and calculating the slope of the medium-term portion of the volatility index futures curve may include subtracting the value of a four-month futures contract for the volatility index on a given day from the value of a seven-month futures contract on the volatility index on the same day.

A system for maintaining a relative value volatility index is also disclosed. The system includes a server having a controller running on a processor and being configured to interface with a plurality of databases to access information regarding an implied volatility index, and an index calculator module interfacing with the controller and being configured to receive the information regarding the implied volatility index and to calculate a daily signal based on the slope of a short-term portion of the volatility index futures curve and the slope of a medium-term portion of the volatility index futures curve. The index calculator module is further configured to calculate a daily value for the relative value volatility index based on the signal.

A processor-implemented method for maintaining a portfolio based on a relative value volatility index is also disclosed. The method includes calculating, using an index calculator module, a daily signal based on the slope of a short-term portion of a volatility index futures curve and the slope of a medium-term portion of the volatility index futures curve; calculating a daily value for the relative value volatility index based on the signal and using the index calculator module; and creating a financial product using an index product marketer module, wherein the value of the financial product is determined by the daily value of the relative value volatility index.

In one embodiment, the RVOL may be used to create a rule-based signal-driven algorithmic index that seeks to generate returns by trading the relative performance of the short-term of an implied volatility curve for a stock index versus a medium-term of the same implied volatility curve, as tracked by a short-term index and a medium-term index, respectively, based on the steepness of the short-term end of the curve versus the steepness of the medium-term end of the curve. The RVOL may provide exposure to a notional portfolio that comprises either (1) equal notional allocation to (i) long exposure to the short-term index and (ii) short exposure to the medium-term index; or (2) equal notional allocation to (i) short exposure to the short-term index and (ii) long exposure to the medium-term index.

The notional allocation to the short-term index and the medium-term index may be equal, albeit in opposite directions, and the size of this allocation may be determined based on the value of a signal. In one embodiment, the signal may be calculated based on the difference between (1) the difference between two short-term volatility index futures and (2) the difference between two medium-term volatility index futures. As the signal changes, the allocation of the portfolio may gradually change over time.

In another embodiment, the RVOL may be used to create a rule-based signal-driven algorithmic index that seeks to generate positive returns by harvesting the roll yield (whether positive or negative) of an implied volatility futures curve for a stock index. The RVOL may establish offsetting long and short positions in the short-term and mid-term portions of the curve and may go long or short either portion, or be positioned flat.

The RVOL may take any one of several positions, including “short calendar spread,” or convex, meaning that the RVOL is long the short-term portion of the curve while simultaneously being short the mid-term portion of the curve; and “long calendar spread” or concave, meaning that the RVOL is long the mid-term portion of the curve while simultaneously being short the short-term portion of the curve.

In one embodiment, both the decision whether to track a convex position or concave position and the scale of the positioning (ranging, for example, between −30% to +30%) are determined by the relative steepness of the two portions of the curve. The short-term and mid-term portions of the curve may be represented by two volatility indices, a short-term index an a medium-term index.

The RVOL may be configured as any suitable index type, including a total return index, which among other things may include exposure to a notional cash investment; and an excess return index, which may reflect exposure to the RVOL without any reference to any return on a notional cash investment. The total return embodiment of the RVOL may include a notional cash component resulting from, among other things, income generated by the initial cash investment and the RVOL. The excess return embodiment of the RVOL may measure the rate of return of the RVOL on an unfunded basis.

In one embodiment, the RVOL may examine the relative steepness of the two segments of the curve on a daily basis to determine what positioning to take. In general, at any time, the RVOL will be in one of three positions relative to the implied volatility futures curve: (1) long the short-term and short the mid-term (convex position); (2) an all cash position (in the case of a total return index) or no position (in the case of an excess return index) (both of these positions are referred to as flat); and (3) short the short-term and long the mid-term (concave position). The extent to which the Index is long or short may vary daily according to a signal and an algorithm, examples of which are described below.

In one embodiment, the RVOL may be a total return index that at all times provides exposure to a funded investment in 3-month US Treasury Bills. Whenever the Index is not flat, the notional allocation to the short-term index and the medium-term index will be equal, albeit in opposite directions, and the size of this allocation will be determined based on the value of a steepness signal, which may be calculated based on the difference between (1) the difference between two short-term implied volatility futures and (2) the difference between two medium-term implied volatility futures. As the signal changes over time, the allocation of the portfolio may be expected to change.

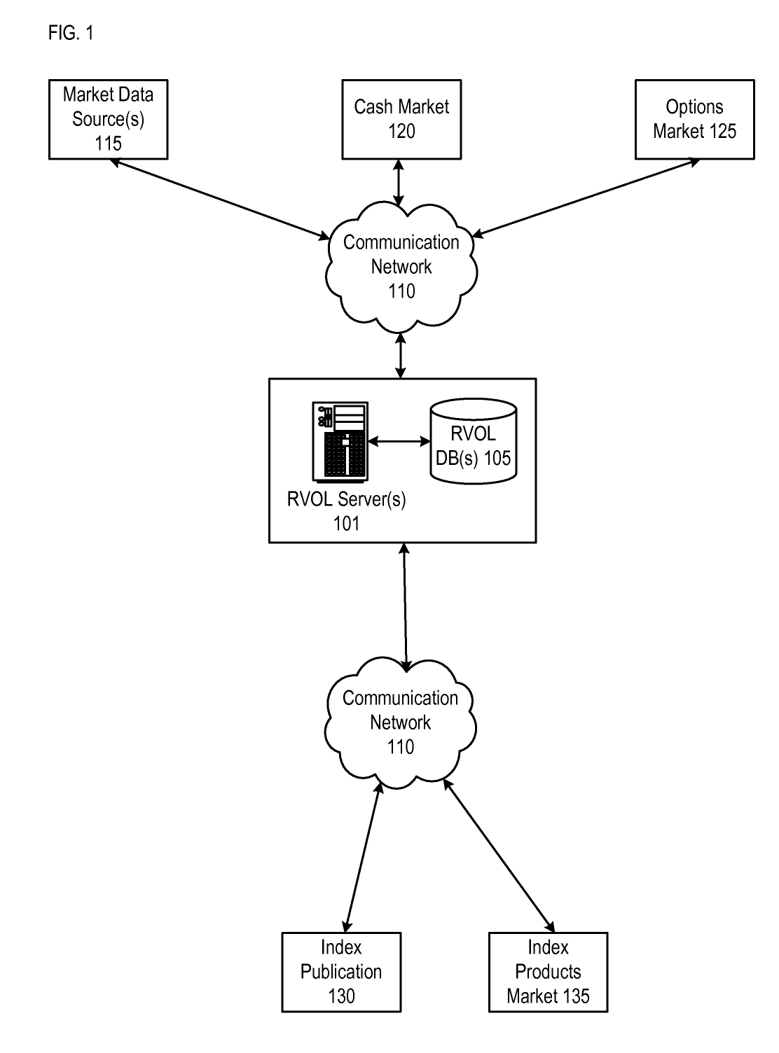

FIG. 1 shows a schematic illustration of data flows between RVOL components and affiliated entities in one embodiment of RVOL operation. The RVOL may, in one implementation, comprise an entity including one or more RVOL servers 101 implementing RVOL functionality and communicatively coupled to one or more RVOL databases (“DBs”) 105 configured to store RVOL data. The RVOL server 101 may be further coupled by a communication network 110 to one or more market data sources 115, such as one or more market data feeds (e.g., Bloomberg's PhatPipe, Dun & Bradstreet, Reuter's Tib, Triarch, and the like) to draw financial data used in the generation and maintenance of RVOL indices. A wide variety of different data may be drawn, such as, but not limited to: current and historical prices of one or more underlying instruments, indices, portfolios, or other assets, current and historical prices for put and call options on such underlying assets, and the like.

The RVOL may process received market data to generate index values or to determine allocations of funds underlying indices to various investments. In an implementation where the instruments underlying a RVOL index are to be actually obtained, orders for such investments at the determined levels may be placed by the RVOL with one or more cash market 120 or options market 125 exchanges or with other suitable outlets, such as may include one or both of primary and secondary markets. In another implementation, indices may be based on portfolios that are simulated, synthetic, and the like. In such an implementation, orders may still be placed by the RVOL with one or more cash market 120 or options market 125 exchanges or other suitable outlets to generate financial instruments or initiate a transaction involving financial instruments based on RVOL-generated indices.

Index values associated with the portfolio of investments, real or synthetic, that are generated or administered by the RVOL server 101 may be stored in the RVOL database 105 for future retrieval, display, report generation, updating, and the like. In one implementation, the RVOL may further provide index values via a communication network 110 for publication 130, such as to a website, to a market data resource, to a ticker, as a report, and the like. The RVOL may further be configured to generate one or more financial instruments with values linked to the value of one or more RVOL generated indices. Such instruments may include, but are not limited to, equities, debts, derivatives, notes (e.g., structured notes), stocks, preferred shares, bonds, treasuries, debentures, options, futures, swaps, rights, warrants, commodities, currencies, funds, long and short positions, Exchange Traded Funds (ETFs), Exchange Traded Notes (ETNs), insurance and risk transfer agreements, annuities, and other assets or investment interests. RVOL-generated instruments may then be made available for purchase in one or more index products markets 135.

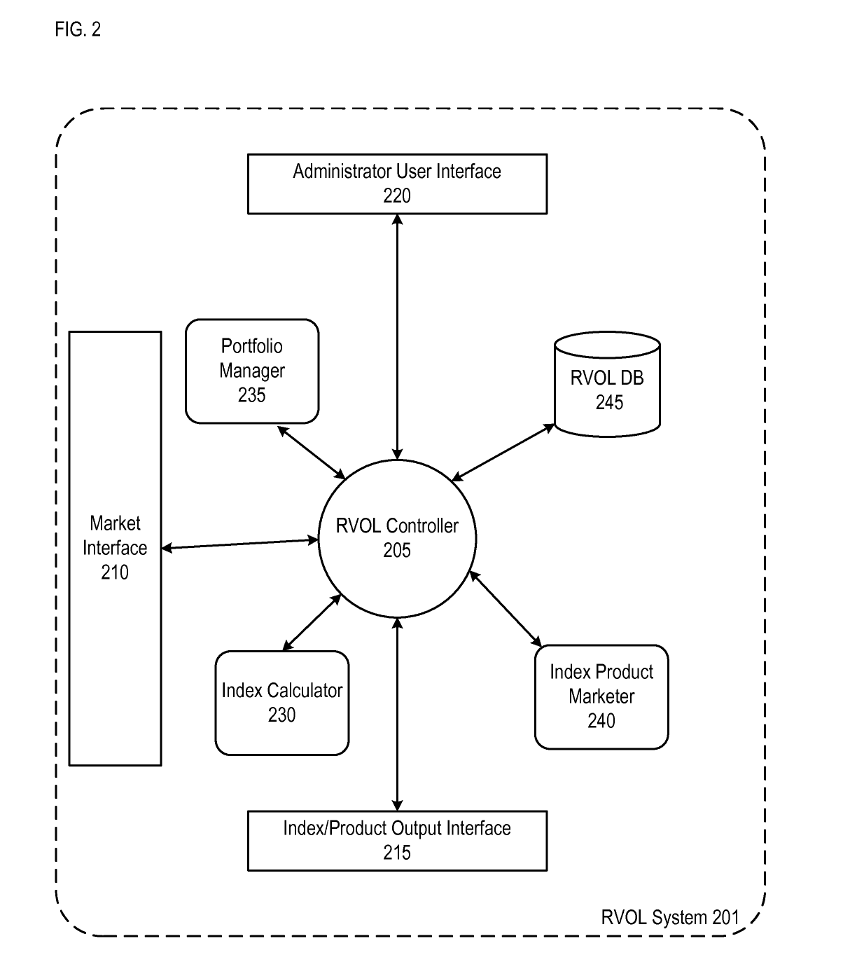

FIG. 2 shows aspects of RVOL architecture in block-diagram form and data flow between and among RVOL components in one embodiment of RVOL operation. A RVOL system 201 may include a number of operational modules and/or data stores configured to carry out RVOL features and/or functionality. A RVOL controller 205 may serve a central role in some embodiments of RVOL operation, serving to orchestrate the reception, generation and distribution of data and/or instructions to, from, and between RVOL modules and to allow further analysis of data generated during RVOL operation. The RVOL controller 205 may be coupled to one or more operational modules configured to implement various features associated with embodiments of RVOL operation.

In one implementation, the RVOL controller 205 may be coupled to a market interface 210 configured to query and/or draw market data from one or more market data sources; place market orders or otherwise effectuate market transactions; receive confirmations of requested instrument transaction fulfillment; and to perform other suitable functions.

In one implementation, the RVOL controller 205 may further be coupled to an index/product output interface 215, which may be configured to publish index values; generate or request generation of reports containing index values and/or the values of associated financial products; generate financial products with values linked to RVOL generated index values; provide RVOL financial products for sale on one or more markets or exchanges; and the like. In one implementation, the RVOL controller 205 may further be coupled to an administrator user interface 220 configured to provide an interface through which an administrator can monitor and interact with RVOL system settings and portfolio allocations, manage data, and the like. For example, in one implementation, a RVOL administrator may interface with the RVOL system via the administrator user interface to adjust the values of index calculation or publication times and other parameters associated with the index, as may be needed or desired within a given application of the RVOL.

In one implementation, the RVOL controller 205 may further be coupled to an index calculator module 230 configured to calculate official index values. In one implementation, the index value may be calculated on a daily basis, such as at the end of each U.S. trading day.

The index calculator 230 may also be configured to track and monitor values of components of one or more underlying real or simulated RVOL portfolios and to calculate index values based on the value of these components. In one implementation, the index calculator may be configured to calculate the excess rate of return of a relative value volatility strategy. A portfolio generated by this strategy may include a long/short delta-one position in Short-Term (ST) index units, and a short/long delta-one position in Medium Term (MT) index units.

In one implementation, the RVOL controller 205 may further be coupled to a portfolio manager module 235 configured to manage one or more portfolios of financial instruments underlying one or more RVOL indices. Such portfolios may, in various implementations, comprise actual investments or be simulated or synthetic portfolios with values tied to specified investments. In one implementation, the portfolio manager module may be configured to administer a portfolio underlying the RVOL index comprising positions on a plurality of options on one or more underlying stocks, bonds, debts and/or debentures, currencies, commodities, real properties, options, indices, portfolios, and like assets.

In one implementation, the RVOL controller 205 may further be coupled to an index product marketer module 240 configured to generate, market, manage, and/or the like financial products and/or instruments with values tied to one or more RVOL indices. In various implementations, the index product marketer module may be configured to generate and manage any of a wide variety of different financial products, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. In one implementation, the index product marketer module may initiate the formation of a corporation, special purpose entity, fund, and/or the like entity which owns a portfolio underlying a RVOL index and which issues shares with values tied to that index.

In one implementation, the RVOL controller 205 may further be coupled to one or more databases 245 configured to store a variety of data associated with RVOL operation in various embodiments. For example, in one implementation, the RVOL database may include tables for storing information associated with current and/or historical RVOL index values, underlying portfolios and/or portfolio elements, RVOL index linked financial products, market data, transaction orders, transaction histories, and/or the like. Further detail surrounding such tables is provided below.

In one implementation, a RVOL index value may be calculated each day. For example, at the end of each index calculation day, the RVOL portfolio may be rebalanced so that its exposure to a short-term volatility futures index (ST index) and to a medium-term volatility futures index (MT index) is allocated as prescribed by a relative value volatility strategy. A daily rebalancing mechanism may include three components: daily constant proportion rebalancing, signal-based weight adjustments, and a disruption adjustment.

Daily constant proportion rebalancing may include adjusting the number of ST index units and the number of MT index units within the RVOL index so that the notional allocation to both the ST index and the MT index is as prescribed by the relative value volatility strategy. Signal-based weight adjustments may be made each day by determining a signal for a given date, which may dictate the target weights for both the ST index and the MT index portions of the RVOL index for the following index calculation day. If any index calculation day is disrupted, the index calculation day may be adjusted to be the immediately following index calculation day that is not a disrupted day.

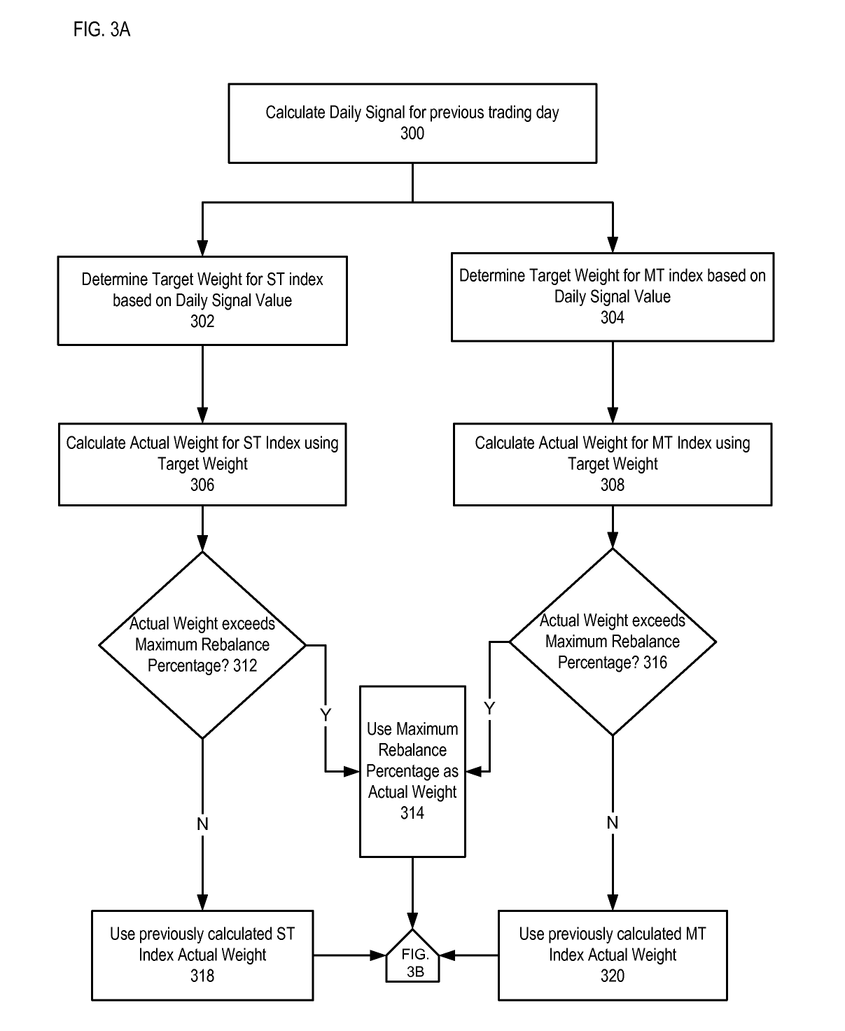

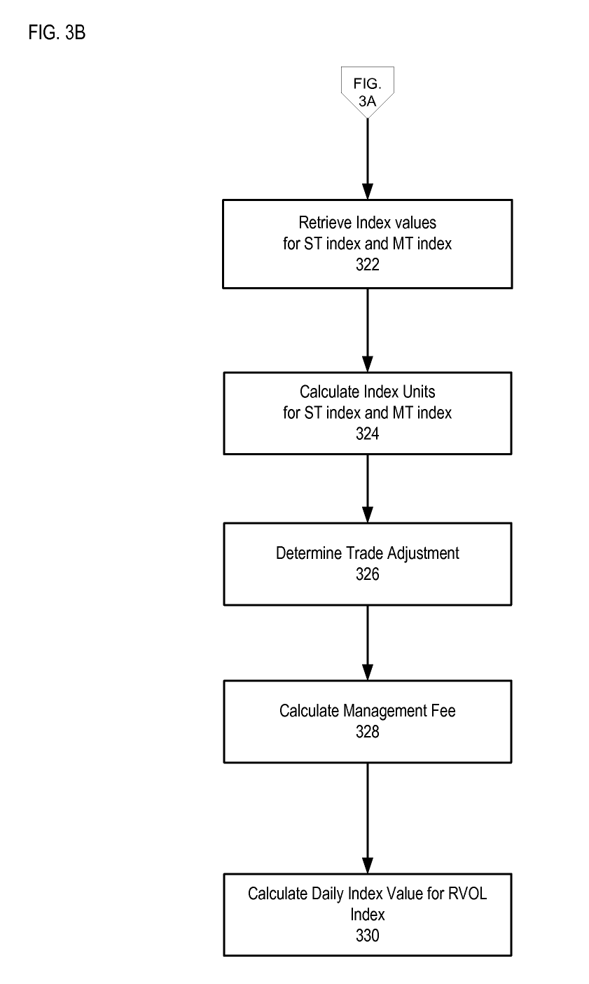

FIGS. 3A and 3B illustrate a logic flow of an exemplary embodiment of a process for calculating the daily value of an RVOL index. As shown in FIG. 3A, at 300, a daily signal is calculated based on market information from the previous trading day. At the end of each index calculation day, this signal may be calculated to determine the allocation to an ST index and an MT index, which will in turn be used to calculate a daily value for the RVOL index at the close of the following index calculation day. As an example, the signal for the index calculation day may be calculated using the following formula:

Signalₜ=ST_Slopeₜ−MT_Slopeₜ
Where
“ST_Slopeₜ” (front end of the curve) represents the steepness of the short-term futures curve as measured by the difference between the 2^{nd} and the 1^{st} futures and is calculated as:

ST_Slopeₜ=UX2−UX1,
“MT_Slopeₜ” (back end of the curve) represents the steepness of the medium-term futures curve as measured by the difference between the 7^{th} and the 4^{th} futures and is calculated as:

MT_Slopeₜ=UX7ₜ−UX4ₜ,
“UX1ₜ” is the closing level of the 1^{st} Generic ‘UX’ Future on Index Calculation Day, t (UX1 Index)
“UX2ₜ” is the closing level of the 2^{nd} Generic ‘UX’ Future on Index Calculation Day, t (UX2 Index)
“UX4ₜ” is the closing level of the 4^{th} Generic ‘UX’ Future on Index Calculation Day, t (UX4 Index)
“UX7ₜ” is the closing level of the 7^{th} Generic ‘UX’ Future on Index Calculation Day, t (UX7 Index)
In one exemplary embodiment, UX1ₜ, UX2ₜ, UX4ₜ, and UX7ₜ may represent an implied volatility index (such as VIX) futures as of the Index Calculation Day t, whose final settlement dates are after the date t and of those, UX1 may have the shortest maturity, UX2 the 2nd shortest, UX4 the 4th shortest, and UX7 the 7th shortest.

The signal may be calculated daily and may be based on the values of the first, second, fourth, and seventh active volatility futures contracts on the calculation day. As shown in FIG. 3A, at the end of each index calculation day, target weights may be determined for both the ST index portion 302, and the MT index portion 304, of the RVOL index. The level of the signal may drive the exposure to the ST index and the MT index for the RVOL index as of the close of the following day. Table 1 below shows an exemplary range of target weights for both the ST index portion and the MT index portions of the RVOL index as of the close of a given index calculation day (t), which depends on the value for the signal calculated on the previous index calculation day (t−1):

TABLE 1

| Signalₜ₋₁ | ST_Targetₜ | MT_Targetₜ |
|---|---|---|
| (−inf, −3) | 30% | −30% |
| [−3, −2) | 20% | −20% |
| [−2, 0) | 10% | −10% |
| [0, 2) | −10% | 10% |
| [2, 3) | −20% | 20% |
| [3, inf) | −30% | 30% |

Table 1 is an example of suitable target weights, however, any other suitable target weights may also be used. Using the target weights shown in Table 1 as an example, if the value of the one-month volatility futures contract UX1 were equal to 20.0, the value of the two-month volatility futures contract UX2 were equal to 23.25, the value of the four-month volatility futures contract UX4 were equal to 23.95, and the value of the seventh-month volatility future contract UX7 were equal to 25.0, the front-end slope of the volatility curve (ST_Slope) would be equal to 3.25 (UX2−UX1) and the back-end slope of the volatility curve (MT_Slope) would be equal to 1.05 (UX7−UX4). The Signal would then be equal to 2.2 (ST_Slope−MT_Slope). Using the target values from Table 1, a signal value of 2.2 would correspond to an ST_Target value of −20% and an MT_Target value of 20%, since 2.2 is within the range of [2, 3). In other words, the calculated signal would indicate that a short position should be taken in the ST index and a long position should be taken in the MT index.

While the target weights are determined based on the level of the signal, to prevent excessive rebalancing and to ease liquidity constraints, in one embodiment, changes to the actual allocations from one target weight to another may be executed gradually over several index calculation days with no weight change occurring for more than a predetermined maximum rebalance percentage. In one exemplary embodiment, the maximum rebalance percentage may be expressed in basis points (bps). For example the maximum rebalance percentage may be 250 bps, or any other suitable value.

As illustrated in FIG. 3A, the actual weights for the ST index and the MT index may be calculated at 306 and 308, respectively. In one exemplary embodiment, the actual weights for the ST index and the MT index portions of the RVOL index may be calculated as shown below:

ST_Weightₜ=ST_Weightₜ₋₁+Min{MRP, Abs{ST_Targetₜ−ST_Weightₜ₋₁}}*Sign{ST_Targetₜ−ST_Weightₜ₋₁}

MT_Weightₜ=MT_Weightₜ₋₁+Min{MRP, Abs{MT_Targetₜ−MT_Weightₜ₋₁}}*Sign{MT_Targetₜ−MT_Weightₜ₋₁}

### Where

“t−1” is the Index Calculation Day preceding the Index Calculation Day t

“MRP” is the Maximum Rebalance Percentage

“ST_Targetₜ” is the Target Weight applicable to the ST_Index

“MT_Targetₜ” is the Target Weight applicable to the MT_Index

“Sign(x)” is the sign mathematical function, which returns the sign of any real number and is equal to +1 if x is positive and −1 if x is negative.

As shown in FIG. 3A at 310, if the actual weight calculated for the ST index exceeds the maximum rebalance percentage, the maximum rebalance percentage is used as the value for the actual weight, 312. Similarly, at 314, if the actual weight calculated for the MT index is greater than the maximum rebalance percentage, 316, the maximum rebalance percentage is used as the value of the actual weight, 314. In one embodiment, the maximum rebalance percentage may have the same value for both the MT index and the ST index; in another embodiment, there may be two maximum rebalance percentages, one for the ST index portion and one for the MT index portion.

However, if the actual weight calculated for the ST index does not exceed the maximum rebalance percentage, the previously calculated actual index weight for the ST index will be used in the calculation of the RVOL index, as shown at 318. Similarly, if the actual weight calculated for the MT index does not exceed the maximum rebalance percentage, the previously calculated actual index weight for the MT index will be used in the calculation of the RVOL index, as shown at 320 in FIG. 3A.

As shown in FIG. 3B at 322, the index values for the ST index and for the MT index as of the close of the calculation day may be retrieved from a suitable market data feed. As of the close of any index calculation day, the allocation across ST index and MT index may be rebalanced to conform to the prescribed actual weights. In one exemplary embodiment, the corresponding number of index units to be used when calculating the value for the RVOL index may be calculated, as shown at 324 in FIG. 3B, as follows:

$${n}_{t}^{ST\_Index} = \frac{{Index}_{t}}{{ST\_Index}_{t}} * {ST\_Weight}_{t}$$

$${n}_{t}^{MT\_Index} = \frac{{Index}_{t}}{{MT\_Index}_{t}} * {MT\_Weight}_{t}$$

As shown in FIG. 3B at 326, The RVOL index value may also be adjusted for the notional transaction costs incurred as the result of rebalancing of the notional portfolio. In one exemplary embodiment, in connection with each such rebalance, a notional trading adjustment may reduce the level of the RVOL by a predetermined number of basis points. For example, the level of the RVOL may be reduced by ten basis points on the notional amount of the change in the ST index and twenty basis points on the notional amount of the change in the MT index. On an index calculation day t, such a trading adjustment (TAₜ) may be calculated by an index calculator 230. Index calculator 230 may use the following formula to calculate (TAₜ):

TAₜ=TA_STₜ+TA_MTₜ

### Where

“TA_STₜ” is the Trading Adjustment associated with the ST_Index and is calculated as:

TA_STₜ=TA_ST_Pct*Abs{ST_Indexₜ*nₜ^{ST}^{_{—}}^{Index}−ST_Indexₜ₋₁*nₜ₋₁^{ST}^{_{—}}^{Index}}
“TA_MTₜ” is the Trading Adjustment associated with the MT_Index and is calculated as:

TA_MTₜ=TA_MT_Pct*Abs{MT_Indexₜ*nₜ^{MT}^{_{—}}^{Index}−MT_Indexₜ₋₁*nₜ₋₁^{MT}^{_{—}}^{Index}}
“TA_ST_Pct” is the Trading Adjustment applicable to ST_Index and is equal to a predetermined percentage, for example, 0.08%
“TA_MT_Pct” is the Trading Adjustment applicable to MT_Index and is equal to a predetermined percentage, for example, 0.16%

In one exemplary embodiment, as shown at 326 in FIG. 3B, a management fee may also be calculated. This management fee may be subtracted from the value of the RVOL index when calculating the final value of the RVOL index. For example, the management fee may be calculated using the following formula:

Fee_Mgmtₜ=Indexₜ*Fee_Mgt_Pct*Day_Countₜ/365

### Where:

“Indexᵣ” is the Index Value on the Index Calculation Day, t
“Fee_Mgt_Pct” is the annual Management Fee, (for example, 1.00%)
“Day_Countₜ” is the number of calendar days from but excluding the immediately preceding Index Calculation Day t−1 to and including Index Calculation Day t

In another exemplary embodiment, the RVOL index may be published gross of fees. In such an embodiment, management fees would not be calculated.

In some embodiments of the RVOL, a daily accrual value may also be calculated. For embodiments of the RVOL where the RVOL is a total return index, the daily accrual value represents the rate of interest that could be earned on a notional capital investment at the three-month U.S. treasury rate. For embodiments of the RVOL where the RVOL is an excess return index, the daily accrual value will be equal to zero. For total return index embodiments, the daily accrual on a given index calculation day, t, may be calculated using the following formula:

$${DA}_{t} = {( \frac{1}{1 - {TBills}_{t} * ( 91 / 360 )} )}^{\frac{{d}_{t}}{91}} - 1$$

### Where:

“TBillsₜ” for any Index Calculation Day, t is the 3-month rate for United States Treasury Bills (T-Bill rate) on such Index Calculation Day, t; and
   “dₜ” is the number of calendar days from and excluding the current Index Calculation Date, t until and including the following Index Calculation Day, t+1

As shown in FIG. 3B, at 330, the daily index value for the RVOL index may be calculated using the index value from the previous trading day, the calculated index units for both the ST index and the MT index, the retrieved index values for both the ST index and the MT index on the previous trading day and the current trading day, the calculated management fee, the calculated trade adjustment, and the daily accrual.

For example, the daily value of an RVOL index may be calculated using the following formula:

Indexₜ=Indexₜ₋₁+nₜ₋₁^{ST}^{_{—}}^{Index}*[ST_Indexₜ−ST_Indexₜ₋₁]+nₜ₋₁^{MT}^{_{—}}^{Index}*[MT_Indexₜ−MT_Indexₜ₋₁]−Fee_Mgmtₜ₋₁−TAₜ₋₁+Indexₜ₋₁DAₜ₋₁
Where
“t−1” is the index calculation day preceding the index calculation day t;
“Indexₜ₋₁” is the value of the index as of the close of the previous index calculation day, t−1;
“nₜ₋₁^{ST}^{_{—}}^{Index}” and “nₜ₋₁^{MT}^{_{—}}^{Index}” refer to the number of units held in ST_Index and MT_Index, respectively, as of the end of the previous index calculation day, t−1 (as explained above);
“ST_Indexₜ” and “MT_Indexₜ”, respectively, denote the values of ST_Index and the MT_Index as of the close of index calculation day t (as explained above);
“Fee_Mgmtₜ₋₁” denotes a management fee as described above;
“TAₜ₋₁” denotes a liquidity trading adjustment, as described above; and
“DAₜ₋₁” denotes a daily accrual component, as described above.

In one exemplary embodiment, index product marketer 240 may be configured to create and manage one or more exchange-traded volatility products based on the calculated RVOL index values. In one exemplary embodiment, the ST index is the S&P 500 Short-Term Futures index (SPVXSP), which tracks a portfolio of the front two VIX futures, which is rolled each day from the 2nd VIX future to the 1st VIX future for a one-month constant maturity exposure. The VIX is a volatility index published by the Chicago Board Options Exchange (CBOE) that measures implied volatility of the S&P 500 stock market index. In one exemplary embodiment, the MT index is the S&P 500 Medium-Term Futures index (SPVXMP), which tracks a portfolio of the 4th to 7th VIX futures, which is rolled each day from the 7th VIX future to the 4th.

In one exemplary embodiment, the exchange traded volatility products based on the RVOL index values may monetize the steepness in the short end of the VIX futures curve against the steepness of the medium-term range of the VIX futures curve. This may be done by calculating a signal based on the current state of the curve and appropriately capturing the relative value of the roll in the front end versus the roll in the back end of the curve.

### RVOL Controller

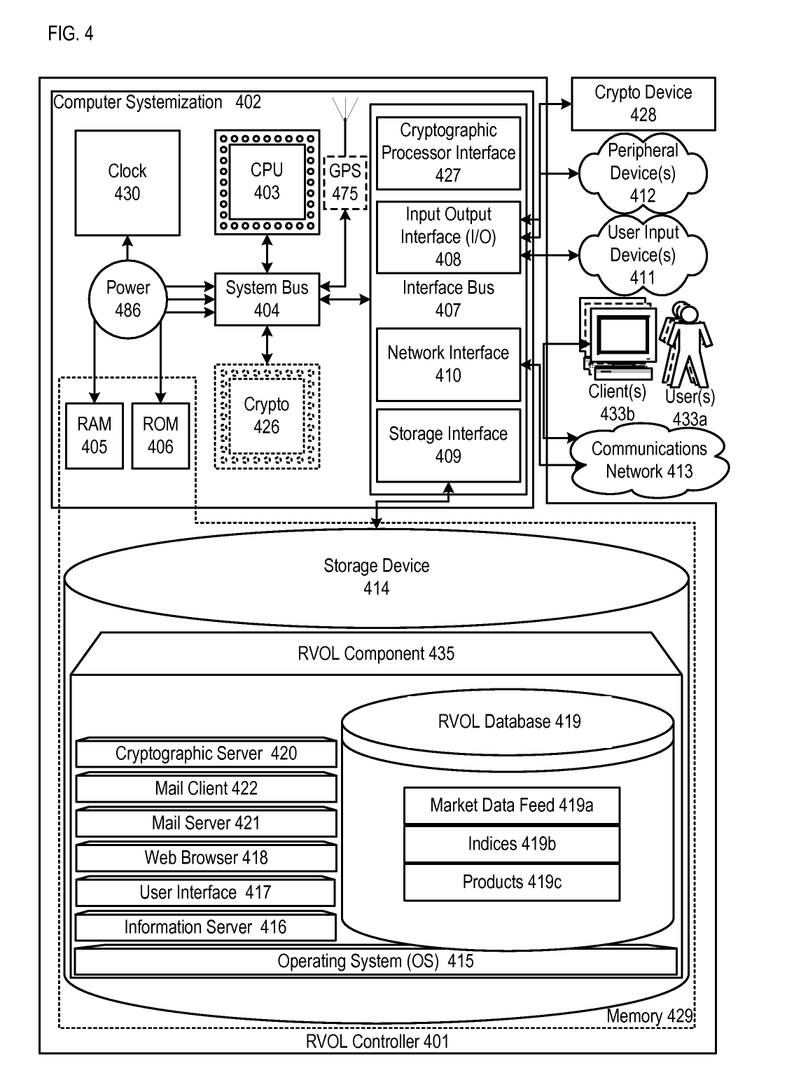

FIG. 4 illustrates inventive aspects of a RVOL controller 401 in a block diagram. In this embodiment, the RVOL controller 401 may serve to aggregate, process, store, search, serve, identify, instruct, generate, match, and/or facilitate interactions with a computer through forward implied variance index and associated financial product generation and management technologies, and/or other related data.

Typically, users, which may be people and/or other systems, may engage information technology systems (e.g., computers) to facilitate information processing. In turn, computers employ processors to process information; such processors 403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the RVOL controller 401 may be connected to and/or communicate with entities such as, but not limited to: one or more users from user input devices 411; peripheral devices 412; an optional cryptographic processor device 428; and/or a communications network 413.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The RVOL controller 401 may be based on computer systems that may comprise, but are not limited to, components such as: a computer systemization 402 connected to memory 429.

### Computer Systemization

A computer systemization 402 may comprise a clock 430, central processing unit (“CPU(s)” and/or “processor(s)” (these terms are used interchangeable throughout the disclosure unless noted to the contrary)) 403, a memory 429 (e.g., a read only memory (ROM) 406, a random access memory (RAM) 405, etc.), and/or an interface bus 407, and most frequently, although not necessarily, are all interconnected and/or communicating through a system bus 404 on one or more (mother)board(s) 402 having conductive and/or otherwise transportive circuit pathways through which instructions (e.g., binary encoded signals) may travel to effect communications, operations, storage, etc. Optionally, the computer systemization may be connected to an internal power source 486. Optionally, a cryptographic processor 426 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the RVOL controller and beyond through various interfaces. Should processing requirements dictate a greater amount speed and/or capacity, distributed processors (e.g., Distributed RVOL), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the RVOL may be achieved by implementing a microcontroller such as CAST's R8051XC2 microcontroller; Intel's MCS 51 (i.e., 8051 microcontroller); and/or the like. Also, to implement certain features of the RVOL, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the RVOL component collection (distributed or otherwise) and/or features may be implemented via the microprocessor and/or via embedded components; e.g., via ASIC, coprocessor, DSP, FPGA, and/or the like. Alternately, some implementations of the RVOL may be implemented with embedded components that are configured and used to achieve a variety of features or signal processing.

Depending on the particular implementation, the embedded components may include software solutions, hardware solutions, and/or some combination of both hardware/software solutions. For example, RVOL features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the RVOL features. A hierarchy of programmable interconnects allow logic blocks to be interconnected as needed by the RVOL system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the RVOL may be developed on regular FPGAs and then migrated into a fixed version that more resembles ASIC implementations. Alternate or coordinating implementations may migrate RVOL controller features to a final ASIC instead of or in addition to FPGAs. Depending on the implementation all of the aforementioned embedded components and microprocessors may be considered the “CPU” and/or “processor” for the RVOL.

### Power Source

The power source 486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 486 is connected to at least one of the interconnected subsequent components of the RVOL thereby providing an electric current to all subsequent components. In one example, the power source 486 is connected to the system bus component 404. In an alternative embodiment, an outside power source 486 is provided through a connection across the I/O 408 interface. For example, a USB and/or IEEE 1394 connection carries both data and power across the connection and is therefore a suitable source of power.

### Interface Adapters

Interface bus(ses) 407 may accept, connect, and/or communicate to a number of interface adapters, conventionally although not necessarily in the form of adapter cards, such as but not limited to: input output interfaces (I/O) 408, storage interfaces 409, network interfaces 410, and/or the like. Optionally, cryptographic processor interfaces 427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 409 may accept, communicate, and/or connect to a number of storage devices such as, but not limited to: storage devices 414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 410 may accept, communicate, and/or connect to a communications network 413. Through a communications network 413, the RVOL controller is accessible through remote clients 433b (e.g., computers with web browsers) by users 433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed RVOL), architectures may similarly be employed to pool, load balance, and/or otherwise increase the communicative bandwidth required by the RVOL controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 410 may be used to engage with various communications network types 413. For example, multiple network interfaces may be employed to allow for the communication over broadcast, multicast, and/or unicast networks.

Input Output interfaces (I/O) 408 may accept, communicate, and/or connect to user input devices 411, peripheral devices 412, cryptographic processor devices 428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 411 may be card readers, dongles, finger print readers, gloves, graphics tablets, joysticks, keyboards, mouse (mice), remote controls, retina readers, trackballs, trackpads, and/or the like.

Peripheral devices 412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the RVOL controller may be embodied as an embedded, dedicated, and/or monitor-less (i.e., headless) device, wherein access would be provided over a network interface connection.

Cryptographic units such as, but not limited to, microcontrollers, processors 426, interfaces 427, and/or devices 428 may be attached, and/or communicate with the RVOL controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 429. However, memory is a fungible technology and resource, thus, any number of memory embodiments may be employed in lieu of or in concert with one another. It is to be understood that the RVOL controller and/or a computer systemization may employ various forms of memory 429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 429 will include ROM 406, RAM 405, and a storage device 414. A storage device 414 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 429 may contain a collection of program and/or database components and/or data such as, but not limited to: operating system component(s) 415 (operating system); information server component(s) 416 (information server); user interface component(s) 417 (user interface); Web browser component(s) 418 (Web browser); database(s) 419; mail server component(s) 421; mail client component(s) 422; cryptographic server component(s) 420 (cryptographic server); the RVOL component(s) 435; and/or the like (i.e., collectively a component collection). These components may be stored and accessed from the storage devices and/or from storage devices accessible through an interface bus. Although non-conventional program components such as those in the component collection, typically, are stored in a local storage device 414, they may also be loaded and/or stored in memory such as: peripheral devices, RAM, remote storage facilities through a communications network, ROM, various forms of memory, and/or the like.

### Operating System

The operating system component 415 is an executable program component facilitating the operation of the RVOL controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the RVOL controller to communicate with other entities through a communications network 413. Various communication protocols may be used by the RVOL controller as a subcarrier transport mechanism for interaction, such as, but not limited to: multicast, TCP/IP, UDP, unicast, and/or the like.

### Information Server

An information server component 416 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the RVOL controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the RVOL database 419, operating systems, other program components, user interfaces, Web browsers, and/or the like.

Access to the RVOL database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the RVOL. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the RVOL as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 417 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 418 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the RVOL enabled nodes. The combined application may be nugatory on systems employing standard Web browsers.

### Mail Server

A mail server component 421 is a stored program component that is executed by a CPU 403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the RVOL.

Access to the RVOL mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 422 is a stored program component that is executed by a CPU 403. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 420 is a stored program component that is executed by a CPU 403, cryptographic processor 426, cryptographic processor interface 427, cryptographic processor device 428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the RVOL may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the RVOL component to engage in secure transactions if so desired. The cryptographic component facilitates the secure accessing of resources on the RVOL and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The RVOL Database

The RVOL database component 419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the RVOL database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the RVOL database is implemented as a data-structure, the use of the RVOL database 419 may be integrated into another component such as the RVOL component 435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 419 includes several tables 419a-c. A market data table 419a may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rft.Multi. An indices table 419b may include fields such as, but not limited to: index_ID, index_name, components, values, history, portfolio_ID, portfolio_components, portfolio_weights, portfolio_values, product_ID(s), restrictions and/or authorizations, index_profile, and/or the like. A products table 419c may include fields such as, but not limited to: product_ID, product_name, index_ID(s), terms, restrictions, transaction_history, values, chain_of_title, and/or the like.

In one embodiment, the RVOL database may interact with other database systems. For example, employing a distributed database system, queries and data access by search RVOL component may treat the combination of the RVOL database, an integrated data security layer database as a single database entity.

In one embodiment, user programs may contain various user interface primitives, which may serve to update the RVOL. Also, various accounts may require custom database tables depending upon the environments and the types of clients the RVOL may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 419a-c. The RVOL may be configured to keep track of various settings, inputs, and parameters via database controllers.

The RVOL database may communicate to and/or with other components in a component collection, including itself, and/or facilities of the like. Most frequently, the RVOL database communicates with the RVOL component, other program components, and/or the like. The database may contain, retain, and provide information regarding other nodes and data.

### The RVOLs

The RVOL component 435 is a stored program component that is executed by a CPU. In one embodiment, the RVOL component incorporates any and/or all combinations of the aspects of the RVOL that was discussed in the previous figures. As such, the RVOL affects accessing, obtaining and the provision of information, services, transactions, and/or the like across various communications networks.

The RVOL component enables the determination of weights for constituents of index-linked financial portfolios, the acquisition and/or maintenance/management of those constituents, the determination of market values and/or returns associated with the indices, the generation of financial products based on the indices, and/or the like and use of the RVOL.

The RVOL component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the RVOL server employs a cryptographic server to encrypt and decrypt communications. The RVOL component may communicate to and/or with other components in a component collection, including itself, and/or facilities of the like. Most frequently, the RVOL component communicates with the RVOL database, operating systems, other program components, and/or the like. The RVOL may contain, communicate, generate, obtain, and/or provide program component, system, user, and/or data communications, requests, and/or responses.

### Distributed RVOLs

The structure and/or operation of any of the RVOL node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the RVOL controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/c
om.ibm.IBMDI.doc/referenceguide295.htm

and other parser implementations:

http://publib.boulder.ibm.com/infocenter/tivihelp/v2r1/index.jsp?topic=/c
om.ibm.IBMDI.doc/referenceguide259.htm

all of which are hereby expressly incorporated by reference.

To address various issues related to, and improve upon, previous work, the application is directed to RELATIVE VALUE VOLATILITY INDEX APPARATUSES, METHODS, AND SYSTEMS. The entirety of this application (including the Cover Page, Title, Headings, Field, Background, Summary, Brief Description of the Drawings, Detailed Description, Claims, Abstract, Figures, Appendices, and any other portion of the application) shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

Depending on the particular needs and/or characteristics of a RVOL user, index underlying assets, financial product issuer, applicable market, market data source(s), index configuration, financial advisor, individual and/or enterprise user, database configuration and/or relational model, data type, data transmission and/or network framework, syntax structure, and/or the like, various embodiments of the RVOL may be implemented that enable a great deal of flexibility and customization. This disclosure discusses embodiments and/or applications of the RVOL directed to generating, managing, administrating disseminating relative value volatility indices (e.g., based on a financial index such as the S&P 500), their underlying portfolios and/or associated financial products. However, it is to be understood that the apparatuses, methods and systems discussed herein may be readily adapted and/or reconfigured for a wide variety of other applications and/or implementations. For example, aspects of the RVOL may be adapted for both and/or either long and/or short positions on variance, variances of multiple and/or foreign instruments or assets (e.g., individual stocks, currencies, precious metals, commodities, and/or the like), generating financial products with different positions with respect to variances, and/or the like. Furthermore, aspects of the RVOL may be configured to generate, administer, and/or manage a wide variety of different financial instruments, securities, and/or the like beyond specific embodiments and/or implementations described in detail herein. For example, indices discussed herein may underly and/or be linked to any of a wide variety of financial products, derivatives, instruments, and/or the like, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. The RVOL may be further adapted to other implementations and/or investment, finance and/or risk management applications.

The invention claimed is:

1. A processor-implemented method for maintaining a relative value volatility index, the method comprising:
calculating, using an index calculator module, a daily signal based on the slope of a short-term portion of a volatility index futures curve and the slope of a medium-term portion of the volatility index futures curve;
calculating a daily value for the relative value volatility index based on the signal using the index calculator module.

2. The method of claim 1, wherein calculating a daily signal comprises calculating the slope of the short-term portion of the volatility index futures curve, calculating the slope of the medium-term portion of the volatility index futures curve, and calculating the difference between these two slopes.

3. The method of claim 2, wherein calculating the slope of the short-term portion of the volatility index futures curve comprises subtracting the value of a one-month futures contract for the volatility index on a given day from the value of a two-month futures contract for the volatility index on the same day.

4. The method of claim 2, wherein calculating the slope of the medium-term portion of the volatility index futures curve comprises subtracting the value of a four-month futures contract for the volatility index on a given day from the value of a seven-month futures contract on the volatility index on the same day.

5. The method of claim 1, wherein calculating a daily value for the relative value volatility index further comprises determining a target weight for a short-term index portion of the relative value volatility index and a target weight for a medium-term index portion of the relative value volatility index based on the signal.

6. The method of claim 5, wherein calculating a daily value for the relative value volatility index further comprises determining an actual weight for the short-term index portion by comparing the target weight for the short-term index portion to a maximum rebalance percentage and using the lesser of the target weight and the maximum rebalance percentage as the actual weight for the short-term index.

7. The method of claim 5, wherein calculating a daily value for the relative value volatility index further comprises determining an actual weight for the medium-term index portion by comparing the target weight for the medium-term index portion to a maximum rebalance percentage and using the lesser of the target weight and the maximum rebalance percentage as the actual weight for the medium-term index.

8. The method of claim 1, further comprising calculating a management fee and subtracting the management fee from the calculated value for the relative value volatility index.

9. The method of claim 1, further comprising calculating a trading adjustment to compensate for transaction costs and subtracting the trading adjustment from the calculated value of the relative value volatility index.

10. The method of claim 1, wherein the relative value volatility index is a total return index.

11. The method of claim 1, wherein the relative value volatility index is an excess return index.

12. The method of claim 1, wherein the volatility index is the Chicago Board Options Exchange Market Volatility Index (VIX).

13. A system for maintaining a relative value volatility index, the system comprising:
a server having a controller running on a processor and being configured to interface with a plurality of databases to access information regarding an implied volatility index;
an index calculator module interfacing with the controller and being configured to receive the information regarding the implied volatility index and to calculate a daily signal based on the slope of a short-term portion of the volatility index futures curve and the slope of a medium-term portion of the volatility index futures curve;
wherein the index calculator module is further configured to calculate a daily value for the relative value volatility index based on the signal.

14. The system of claim 13, wherein the index calculator module is configured to calculate the slope of the short-term portion of the volatility index futures curve, calculate the slope of the medium-term portion of the volatility index futures curve, and calculate the difference between these two slopes.

15. The system of claim 14, wherein the index calculator module is further configured to calculate the slope of the short-term portion of the volatility index futures curve by subtracting the value of a one-month futures contract for the volatility index on a given day from the value of a two-month futures contract for the volatility index on the same day.

16. The system of claim 14, wherein the index calculator module is further configured to calculate the slope of the medium-term portion of the volatility index futures curve by subtracting the value of a four-month futures contract for the volatility index on a given day from the value of a seven-month futures contract for the volatility index on the same day.

17. The system of claim 13, wherein the index calculator module is further configured to determine a target weight for a short-term index portion of the relative value volatility index and a target weight for a medium-term index portion of the relative value volatility index based on the signal.

18. The system of claim 17, wherein the index calculator module is further configured to determine an actual weight for the short-term index portion by comparing the target weight for the short-term index portion to a maximum rebalance percentage and using the lesser of the target weight and the maximum rebalance percentage as the actual weight for the short-term index.

19. The system of claim 17, wherein the index calculator module is further configured to determine an actual weight for the medium-term index portion by comparing the target weight for the medium-term index portion to a maximum rebalance percentage and to use the lesser of the target weight and the maximum rebalance percentage as the actual weight for the medium-term index.

20. A system for maintaining a relative value volatility index, the system comprising:
controller means configured to interface with a plurality of databases to access information regarding an implied volatility index;
an calculator means interfacing with the controller means and being configured to receive the information regarding the implied volatility index and to calculate a daily signal based on the slope of a short-term portion of the volatility index futures curve and the slope of a medium-term portion of the volatility index futures curve;
wherein the calculator means are further configured to calculate a daily value for the relative value volatility index based on the signal.

21. The system of claim 20, wherein the calculator means are configured to calculate the slope of the short-term portion of the volatility index futures curve, calculate the slope of the medium-term portion of the volatility index futures curve, and calculate the difference between these two slopes.

22. The system of claim 21, wherein the calculator means are further configured to calculate the slope of the short-term portion of the volatility index futures curve by subtracting the value of a one-month futures contract for the volatility index on a given day from the value of a two-month futures contract for the volatility index on the same day.

23. The system of claim 21, wherein the calculator means are further configured to calculate the slope of the medium-term portion of the volatility index futures curve by subtracting the value of a four-month futures contract for the volatility index on a given day from the value of a seven-month futures contract for the volatility index on the same day.

24. The system of claim 20, wherein the calculator means are further configured to determine a target weight for a short-term index portion of the relative value volatility index and a target weight for a medium-term index portion of the relative value volatility index based on the signal.

25. The system of claim 24, wherein the calculator means are further configured to determine an actual weight for the short-term index portion by comparing the target weight for the short-term index portion to a maximum rebalance percentage and using the lesser of the target weight and the maximum rebalance percentage as the actual weight for the short-term index.

26. The system of claim 24, wherein the calculator means is further configured to determine an actual weight for the medium-term index portion by comparing the target weight for the medium-term index portion to a maximum rebalance percentage and to use the lesser of the target weight and the maximum rebalance percentage as the actual weight for the medium-term index.

27. A processor-implemented method for maintaining a portfolio based on a relative value volatility index, the method comprising:
calculating, using an index calculator module, a daily signal based on the slope of a short-term portion of a volatility index futures curve and the slope of a medium-term portion of the volatility index futures curve;
calculating a daily value for the relative value volatility index based on the signal and using the index calculator module; and
creating a financial product using an index product marketer module, wherein the value of the financial product is determined by the daily value of the relative value volatility index.
